(19) United States
(12) Patent Application Publication
(10) Pub. No.: US 2024/0032592 A1
(43) Pub. Date: Feb. 1, 2024

(54) UNIVERSAL CAP FOR E-CIGARETTES

(71) Applicant: Josh Bubeck, Henderson, NV (US)

(72) Inventor: Josh Bubeck, Henderson, NV (US)

(21) Appl. No.: 17/877,903

(22) Filed: Jul. 30, 2022

(51) Int. Cl. A24F 40/40; A24F 40/10

(52) U.S. Cl. CPC A24F 40/40; A24F 40/10

(57) ABSTRACT

A universal cap assembly that is designed to fit most variations of pen-type e-cigarettes, that is quick and easy to use, and that provides visual and/or tactile clues as to the type of liquid contained in the e-cigarette to which the cap is paired and that creates the illusion that the e-cigarette device is a common ink pen or marker.

### BACKGROUND

Many consumers utilize electronic cigarette devices, also known as e-cigarettes, which are handheld battery-powered vaporizer that simulate smoking, but without tobacco combustion.

E-cigarettes can come in shapes that resemble pens or writing markers of various dimensions which shapes appeal to those consumers who may want to use the device unobtrusively.

The primary parts that make up a pen or writing marker shaped e-cigarette are a mouthpiece on one end, a cartridge which is often transparent or clear, so the consumer can see the liquid contents, a heating element/atomizer, a microprocessor, a battery, and possibly a LED light on the end opposite the mouthpiece.

Cartridges are sold pre-filled with different types of liquid contents, often without any labeling, making it difficult for a consumer with two or more of the same type of e-cigarettes to visually differentiate between liquid contents of the respective e-cigarettes. For various reasons consumers who utilize electronic cigarettes do not want the

devices to be readily identified as electronic cigarettes by others when the devices are not being used.

Therefor there exists a need for a universal cap assembly that is designed to fit most variations of pen-type e-cigarettes, that is quick and easy to use, and that can provide visual and/or tactile clues as to the type of liquid contained in the e-cigarette to which the cap is paired or engaged and that creates the illusion that the e-cigarette device is a common ink pen or marker.

### SUMMARY

A universally fitting pen-type cap that meets the size and physical specifications to fit traditional pen or marker shaped e-cigarettes. The cap is preferably made from a synthetic material, such as polypropylene, from a mold injection. The cap may be made of any other sufficiently rigid and strong material such as metal, polymer, silicone, bamboo, wood and the like. Caps can have different surface textures such as dimpled or smooth and/or can have different colors that allow the consumer to quickly distinguish by visual and/or tactile means between different caps. In broad embodiment, the present invention is a cap intended to conceal an e-cigarette and its liquid contents.

While the foregoing written description of the invention enables one of ordinary skill to make and use what is considered presently to be the best mode thereof, those of ordinary skill will understand and appreciate the existence of variations, combinations, and equivalents of the specific embodiment, and examples herein. The invention should therefore not be limited by the above described embodiment, and examples, but by all embodiments within the scope and spirit of the invention.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The novel features of the disclosure are set forth in the appended claims. However, for purpose of explanation, several embodiments are illustrated in the following drawings.

FIG. 1 illustrates a perspective view of a universal cap with two parallel slots forming a bridge according to an exemplary embodiment;

FIG. 2 illustrates a top view, a side view, a bottom view, a proximal view and a sectional view of a universal cap with two parallel slots forming a bridge according to an exemplary embodiment;

FIG. 3 illustrates an enlarged proximal view of a universal cap with two parallel slots forming a bridge according to an exemplary embodiment;

FIG. 4 illustrates a illustrates an enlarged perspective view of a universal cap with two parallel slots forming a bridge according to an exemplary embodiment;

FIG. 5 illustrates a illustrates perspective views of a pen shaped e-cigarette and universal cap with two parallel slots forming a bridge according to an exemplary embodiment prior to and after being engaged.

FIG. 6 illustrates a illustrates perspective views of a pen shaped e-cigarette and universal cap without two parallel slots forming a bridge according to an alternative exemplary embodiment prior to and after being engaged.

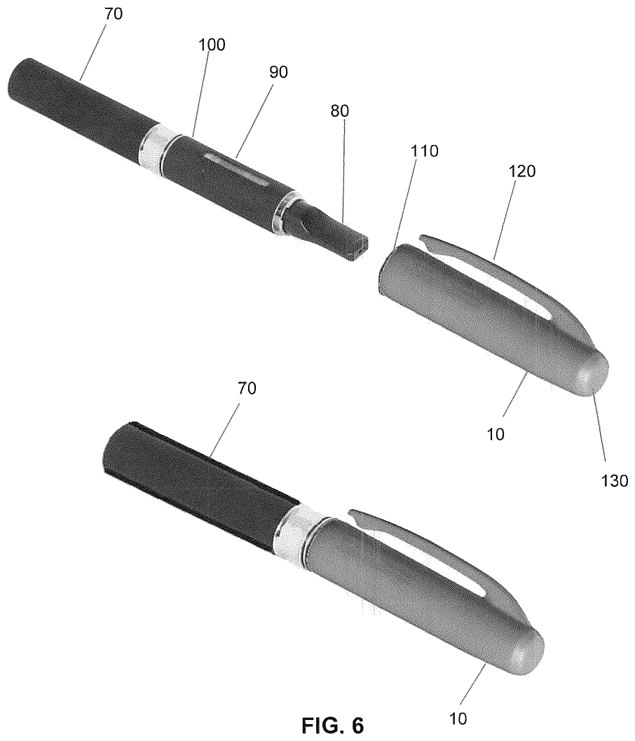

### DETAILED DESCRIPTION

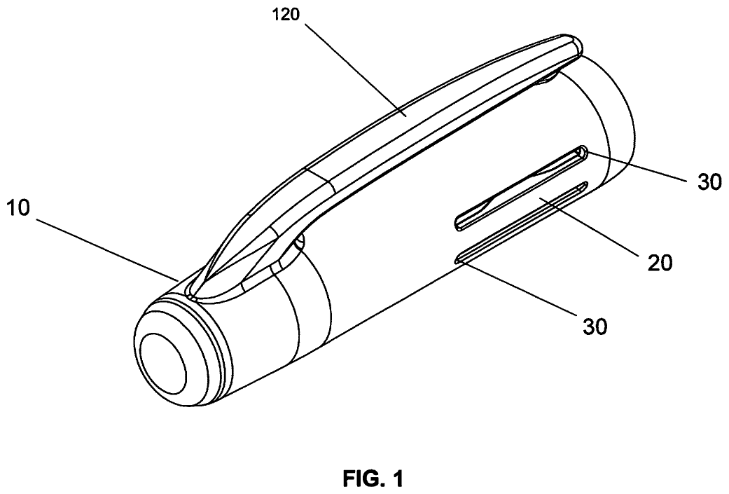

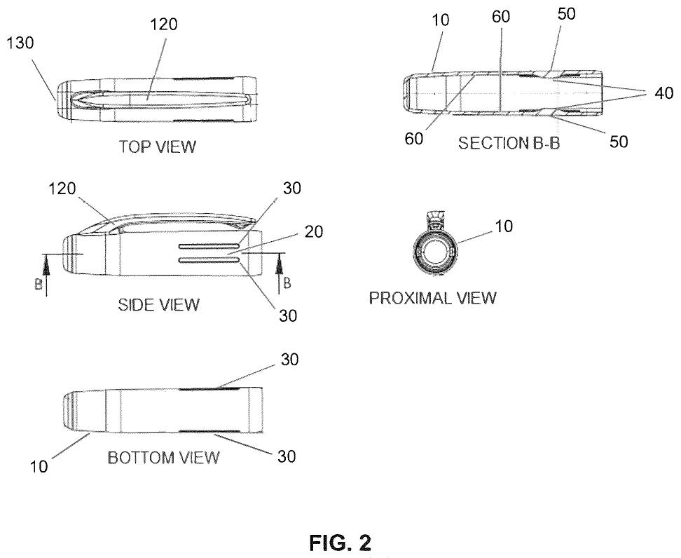

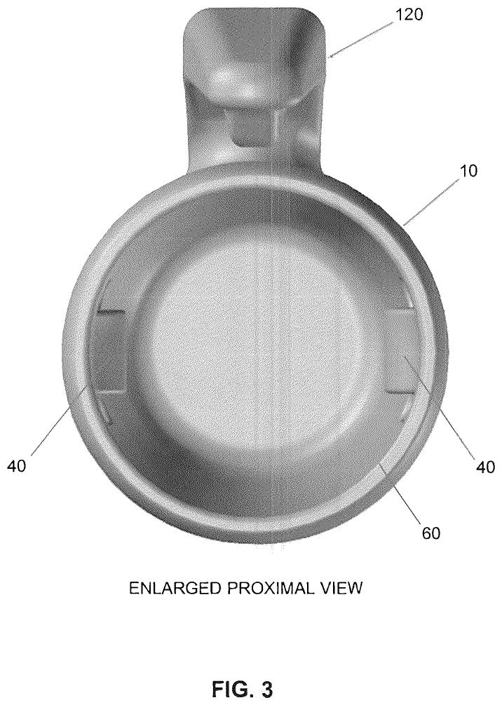

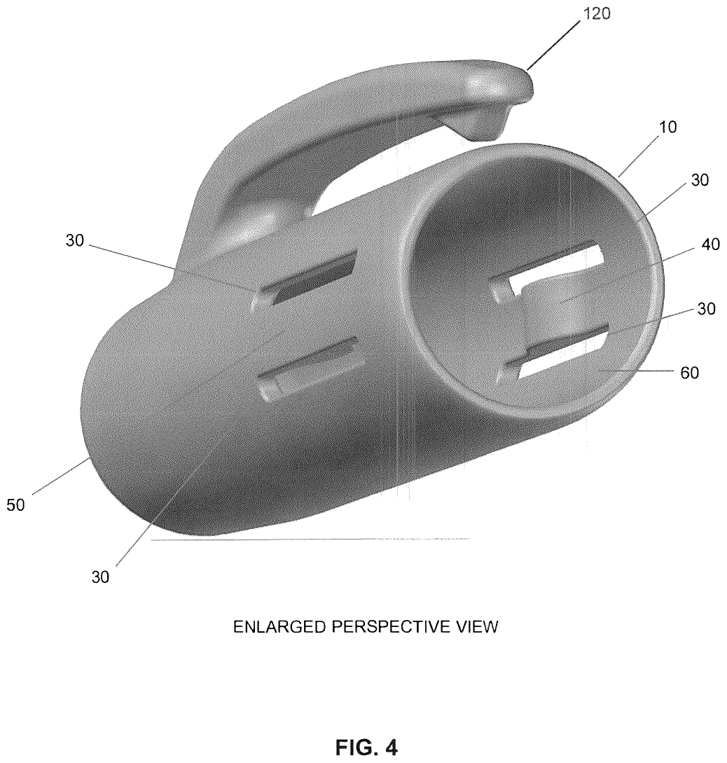

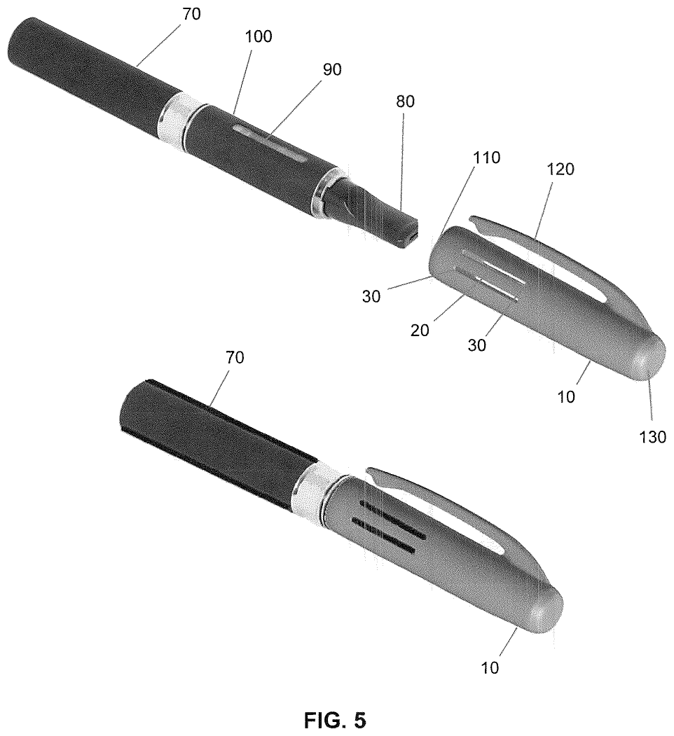

FIGS. 1-5 show a first, preferred embodiment of the pen-type cap of the present invention designated by the numeral 10. FIGS. 1-5 also show a plurality of flexible compression elements 20 or bridges created by two parallel slots 30 on either side of the bridge. These bridges 20 are arrayed opposite each other on the sides of the cap 10 and have both interior surfaces 40 and exterior surfaces 50 as shown best in FIGS. 2 and 4. As best seen in FIGS. 2-4 the interior bridge surface 40 rises above the plane of the interior surface 60 of the cap 10 to form a flexible engagement area. FIG. 5 shows an e-cigarette workpiece 70 comprising a mouthpiece 80, a liquid cartridge 90 and a neck area 100. Also shown in FIG. 5 is an exemplary embodiment of a cap 10 arrayed separate from the e-cigarette workpiece 70, and a cap 10 arrayed in paired or engaged arrangement with the e-cigarette workpiece 70. FIGS. 2 and 5 show the closed distal end 130 and the open proximal end 110 of the cap 10 which slides over the mouthpiece 80 and along the neck 100 of the e-cigarette workpiece 70 such that the cap 10 covers some, if not all, of the liquid cartridge 90 so that the e-cigarette 70 is paired to the cap 10 sufficiently to create the illusion that the e-cigarette device is a common ink pen or marker. As the cap 10 is slid along the neck 100 the interior bridge surfaces 40 contact the surface of the neck 100 and offer suitable flex and resistance to the neck 100 to allow quick and easy pairing of the cap 10 to the e-cigarette workpiece 70 and the quick and easy unpairing of the cap 10 from the e-cigarette workpiece 70 as well.

A second exemplary embodiment may provide a pen-type cap 10 that has one bridge arrayed on only one side of the cap.

A third exemplary embodiment may provide a pen-type cap 10 that has three or more bridges 20 arrayed on the side of the cap 10 at equal or unequal spacing.

A fourth exemplary embodiment may provide a pen-type cap 10 that has a clip 120 arranged on the outside surface of the cap 10 as shown in FIGS. 1-5.

A fifth exemplary embodiment may provide a pen-type cap 10 that replaces the raised interior surface 40 of the bridge with a differently shaped element such as a round knob or a different structural element such as a rubber or felt pad.

A sixth exemplary embodiment may provide a pen-type cap 10 displaying different exterior surface textures such as dimpled or smooth and/or different colors that allow the consumer to quickly distinguish by visual and/or tactile means between different caps.

A seventh and alternative exemplary embodiment may provide a pen-type cap 10 that has no slots nor a bridge and which relies solely on friction between the surface of the neck 100 and inner surface of the cap 40 to hold the cap in place.

As used in this specification and any claims of this application, the terms “e-cigarettes” and “handheld battery-powered vaporizers” all refer to electronic cigarette devices.

In addition, while the examples shown may illustrate the use of two sets of parallel slots arrayed on opposite sides of the cap, one of ordinary skill in the art would recognize that one set of parallel slots may be arrayed on only one side of the cap. One of ordinary skill in the art would also recognize that three or more sets of parallel slots may be arrayed around the sides of the cap.

The foregoing relates to illustrative details of exemplary embodiments and modifications may be made without departing from the scope of the disclosure as defined by the following claims.

We claim:

1. A pen-type cap comprising an interior and an exterior surface and an open proximal end and a closed distal end, which cap is configured to substantially receive and conceal a mouthpiece and a liquid cartridge and a neck of an e-cigarette workpiece.

2. The pen-type cap of claim 1 further comprising;
a flexible compression element or bridge arrayed on the side of the cap which bridge is created by two parallel slots on either side of the bridge wherein the bridge has both an interior surface and an exterior surface, wherein:
the interior bridge surface rises above the plane of the interior surface of the cap to form a flexible engagement area which offers suitable flex and resistance to the neck to allow quick and easy pairing of the cap to the e-cigarette workpiece and the quick and easy unpairing of the cap from the e-cigarette workpiece as well.

3. The pen-type cap of claim 1 further comprising;
a plurality of flexible compression elements or bridges arrayed on the side of the cap at equal or unequal spacing which bridges are created by two parallel slots on either side of each bridge wherein each bridge has both an interior surface and an exterior surface, wherein:
the interior bridge surface rises above the plane of the interior surface of the cap to form a flexible engagement area which offer suitable flex and resistance to the neck to allow quick and easy pairing of the cap to the e-cigarette workpiece and the quick and easy unpairing of the cap from the e-cigarette workpiece as well.

4. The pen-type cap of claim 2 wherein the flexible engagement area has the shape of a round knob.

5. The pen-type cap of claim 2 wherein the flexible engagement area is a rubber pad.

6. The pen-type cap of claim 2 wherein the flexible engagement area is a felt pad.

7. The pen-type cap of claim 1 further comprising a clip arranged on the outside surface of the cap.

8. The pen-type cap of claim 2 further comprising a clip arranged on the outside surface of the cap.

9. The pen-type cap of claim 3 further comprising a clip arranged on the outside surface of the cap.

10. The pen-type cap of claim 1 further comprising a unique combination of an exterior surface texture and a color that allow the consumer to quickly distinguish by visual and tactile means between different caps.

11. The pen-type cap of claim 2 further comprising a unique combination of an exterior surface texture and a color that allow the consumer to quickly distinguish by visual and tactile means between different caps.

12. The pen-type cap of claim 3 further comprising a unique combination of an exterior surface texture and a color that allow the consumer to quickly distinguish by visual and tactile means between different caps.
